(19) United States
(12) Patent Application Publication
(10) Pub. No.: US 2014/0156324 A1
(43) Pub. Date: Jun. 5, 2014

(54) SELECTIVE AUTOMATED TRANSFORMATION OF TASKS IN CROWDSOURCING SYSTEMS

(71) Applicant: INTERNATIONAL BUSINESS MACHINES CORPORATION, Armonk, NY (US)

(72) Inventors: Osamuyimen T. Stewart, Piscataway, NJ (US); Maja Vukovic, New York, NY (US)

(73) Assignee: INTERNATIONAL BUSINESS MACHINES CORPORATION, Armonk, NY (US)

(21) Appl. No.: 13/706,008

(22) Filed: Dec. 5, 2012

(51) Int. Cl. G06Q 10/06

(52) U.S. Cl. CPC G06Q 10/06311
USPC 705/7.13

(57) ABSTRACT

An embodiment of the invention is associated with a system disposed to post software related tasks to a crowdsourcing marketplace for execution. Prior to posting a specified task, it is determined whether the specified task comprises a complex task. Responsive to determining that the specified task comprises a complex task, the specified task is evaluated with respect to a first criterion, to determine whether the specified task should be decomposed into two or more atomic tasks. Responsive to determining that the specified task does not comprise a complex task, the specified task is evaluated with respect to a second criterion, to determine whether the specified task should be combined with other tasks into a bundled task.

### BACKGROUND

1. Field

The invention disclosed and claimed herein generally pertains to crowdsourcing software related tasks, wherein a specified task may be evaluated automatically to determine its complexity. The task may then be processed further, depending on the result of the evaluation.

2. Description of the Related Art

As is known by those of skill in the art, crowdsourcing has developed as an increasingly popular approach for performing certain kinds of important tasks. In a crowdsourcing effort or procedure, a large group of organizations, individuals and other entities that desire to provide pertinent services, such as a specific community of providers or the general public, are invited to participate in a task that is presented by a task requester. Examples of such tasks include, but are not limited to, developing specified software components or the like. As used by those of skill in the art, and also as used herein, the term “crowdsourcing marketplace” means or refers to all the prospective providers of crowdsourcing services for a given type of task, collectively.

Currently, a crowdsourcing platform may serve as a broker or intermediary between the task requester and the crowdsourcing marketplace. Crowdsourcing platforms generally allow requesters to publish or broadcast their tasks to the crowdsourcing marketplace, and further allow a participating provider that is successful in completing a task to receive incentives or other monetary awards.

At present, however, there is no systematic way to design and post or deliver tasks to the crowdsourcing marketplace. Details of these activities are typically left to the crowdsourcing task requesters, which often results in sub-optimal and inefficient crowdsourcing campaigns. Accordingly, the ability of enterprises and entrepreneurs to successfully leverage and scale crowdsourcing campaigns is significantly limited. Moreover, lack of domain expertise on the part of task creators reduces response by providers in the crowdsourcing marketplace. There also tends to be a mismatch between a requested task, and the distribution of pertinent skills for that task in the marketplace.

### SUMMARY

Embodiments of the invention provide intelligent assignment of tasks that takes into account crowd participation inequalities and provider skills distribution. One embodiment, directed to a method, is associated with a system disposed to post software related tasks to a crowdsourcing marketplace for execution. The method includes the step of prior to posting a specified task to the crowdsourcing marketplace, determining whether or not the specified task comprises a complex task. The method further includes, responsive to determining that the specified task comprises a complex task, evaluating the specified task with respect to at least a first criterion, to determine whether the specified task should be decomposed into two or more atomic tasks. The method further includes, responsive to determining that the specified task does not comprise a complex task, evaluating the specified task with respect to at least a second criterion, to determine whether the specified task should be combined with one or more other tasks into a bundled task.

### BRIEF DESCRIPTION OF THE SEVERAL VIEWS OF THE DRAWINGS

FIG. 1 is a schematic diagram illustrating a crowdsourcing process in accordance with an embodiment of the invention.

FIG. 2 is a schematic diagram showing a flowchart depicting steps for an embodiment of the invention, and further showing exemplary parameters that pertain to some of the steps.

FIG. 3 is a flowchart showing steps for a method comprising an embodiment of the invention.

FIG. 4 is a block diagram showing a network of data processing systems in which an embodiment of the invention may be implemented.

FIG. 5 is a block diagram showing a computer or data processing system that may be used in implementing embodiments of the invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

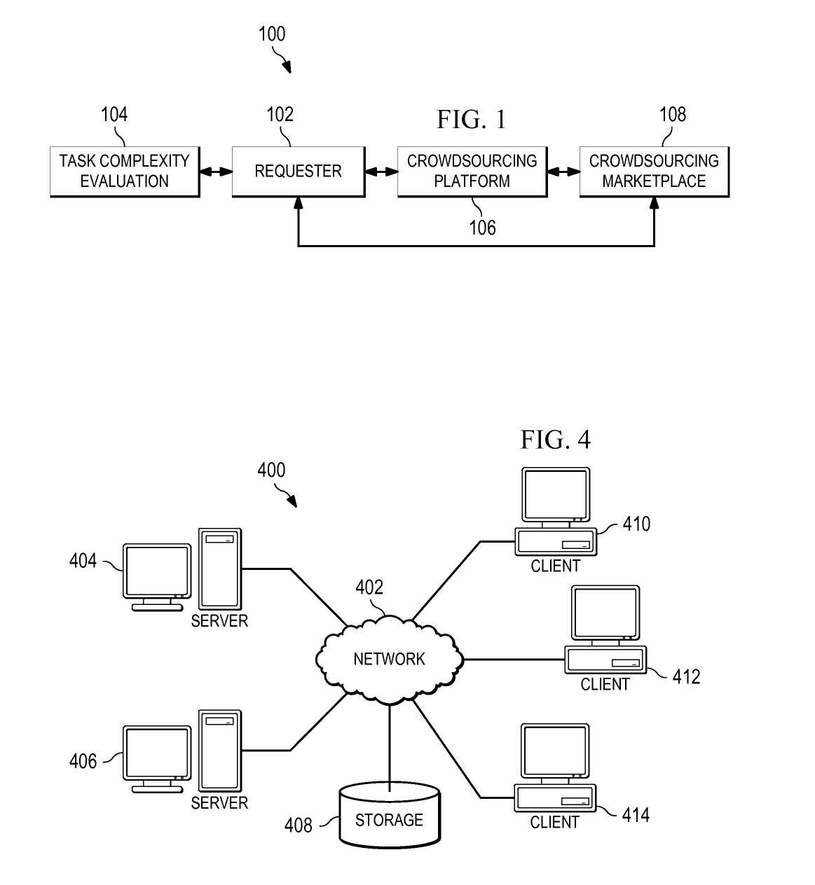

Referring to FIG. 1, there is shown a schematic diagram that illustrates a crowdsourcing system and process 100, and respective entities engaged in such process, as modified by an embodiment of the invention. Generally, requester 102 is an entity such as a business enterprise or other organization that desires to have a particular task performed. The task, for example, could be developing or testing a specified software component, or could be another example such as an example described hereinafter in further detail. However, the invention is not limited thereto.

Requester 102 specifies a task requirements description, and provides acceptance criteria to define successful task completion. Requester 102 could also specify start and end dates, and incentives or rewards. Moreover, in accordance with an embodiment of the invention, the requester uses a task complexity evaluation component 104, as described hereinafter in further detail, to determine or assess the complexity of the task.

Requester 102 initiates the crowdsourcing process by submitting a request for performance of the particular task to a crowdsourcing platform 106. The platform 106 is a broker that posts or presents the task request to the crowdsourcing marketplace 108. This marketplace comprises all the providers of software or other services who may be interested in performing the task, and have the skills and capability to do so. One of these providers may then be subsequently selected to complete the task. Also, if requester 102 is a large corporate entity or the like, crowdsourcing platform 106 could be another component of the same large entity.

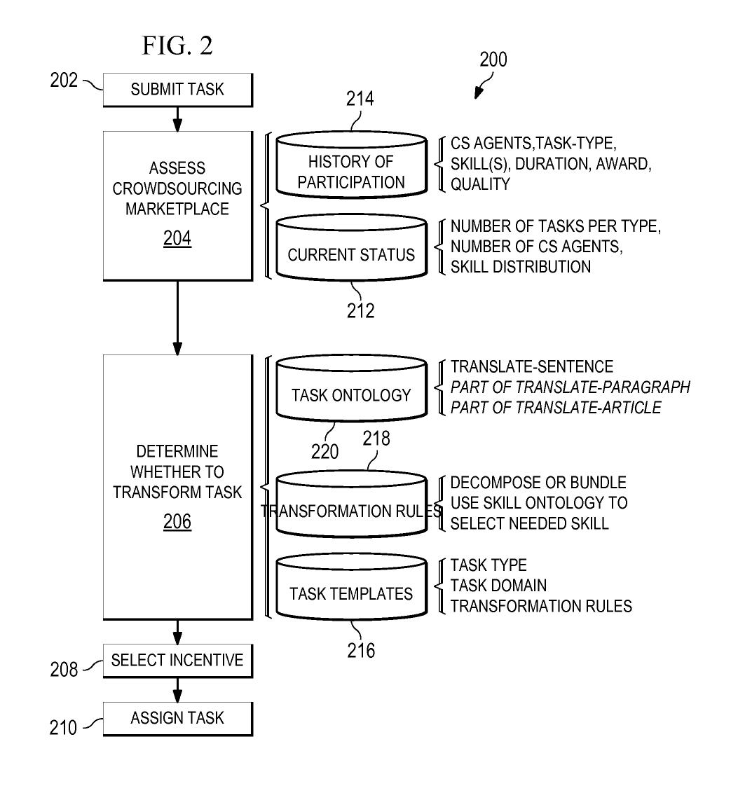

Referring to FIG. 2, there are shown steps of a process 200 carried out by a task requester, such as requester 102, to prepare a specified task for submission or assignment to crowdsourcing marketplace 108. In accordance with embodiments of the invention, it has been recognized that the degree of complexity of a task should be considered, with respect to the crowdsourcing marketplace available to carry out that task. As used herein, the term “complex task” refers to a task that requires the performance of at least two discrete or identifiable smaller tasks, or sub-tasks or atomic tasks. Also, the complexity of a given task increases, as the number of atomic tasks included in the given task increases.

As an example of a complex task as used herein, the task could be developing a specified software component. This task would require the atomic task or sub-task of creating the specified software component. However, it could further require the atomic task or sub-task of testing the created software, to ensure that the software component met all requirements and specifications. These two atomic tasks could require different resources, and also different persons having different skills, in order to carry them out.

In making the invention, it was recognized that as tasks submitted for crowdsourcing become increasingly complex, the crowdsourcing marketplace available for performing such tasks correspondingly diminishes. If a task is sufficiently complex, there may be only a small number of crowdsourcing providers, or even none at all, who have both the capability and interest for the task. Also, if the number of available providers is small, the competition for the services of these few available providers, from other entities that want their crowdsourcing tasks to be carried out, can be very substantial. As a result, the incentive or other cost required to get any of these providers to accept the task may be unacceptably high.

As a further consideration, it was recognized that for certain discrete atomic tasks, or tasks that are very limited in scope, there generally will not be a problem in finding providers in the crowdsourcing marketplace who are willing to accept such tasks. However, it could be very cost inefficient to submit these atomic tasks to the crowdsourcing marketplace on an individual basis. For example, the total incentives required to have two or more of these tasks carried out separately by crowdsourcing providers could be significantly higher than the incentive required to carry them out together, after combining or bundling them into a single bundled task.

In view of the above, FIG. 2 shows the process 200 beginning by submitting a specified task at step 202. At step 204, the available crowdsourcing marketplace that pertains to the specified task type is assessed. More particularly, step 204 considers how the relative complexity of the specified task will affect the reception of the specified task by crowdsourcing marketplace providers.

Based on the assessment at step 204, step 206 determines whether or not the specified task should be transformed. If it is complex, the task could be broken into smaller atomic tasks, which would be crowdsourced independently of each other. Another task transformation would be to combine the specified task with one or more other tasks into a bundled task. The bundled task would then be crowdsourced as a single task entity.

At step 208, an appropriate incentive is selected for each task that results from step 206, such as multiple atomic tasks, or a single bundled task. Each such task is then be assigned or submitted to the crowdsourcing marketplace, at step 210.

Referring further to FIG. 2, there are shown crowdsourcing marketplace parameters 212-214, which may be useful for the assessment of step 204. Current status parameters 212 include the then current status of available crowdsourcing providers. This status information includes the number of tasks, of each of a number of pertinent task types, that a provider can carry out. Further examples of status information include the number of crowdsourcing agents that a provider has, and the distribution of pertinent skills among the agents.

Parameters 214 provide pertinent background information for respective crowdsourcing agents. This includes, for example, the types of tasks they have performed previously, pertinent skills, quality of previous work, length of relevant experience, and any significant awards.

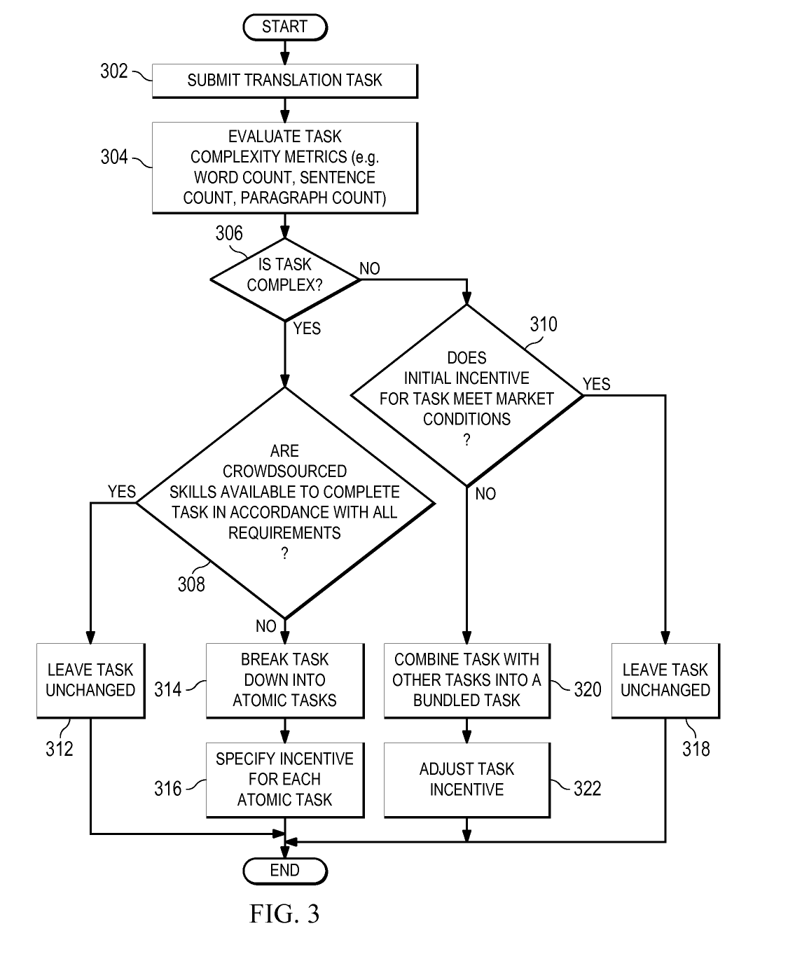

Exemplary parameters pertaining to assessment of the available crowdsourcing marketplace are also described hereinafter in further detail, in connection with FIG. 3.

To illustrate step 206, which requires determining whether or not to transform a given task, a particular task example is provided. The example pertains to translating a body of text comprising an article or other document from a first natural language to a second natural language. Initially, a task template 216 is selected, according to the task type and task domain. For a particular task type and domain, there would be a corresponding set of transformation rules 218.

The rules 218 furnish guidance for determining whether the task should be decomposed into two or more smaller tasks, bundled with other tasks into a larger composite task, or left unchanged. The rules may also provide an ontology of skills needed to perform the task.

FIG. 2 further shows a task ontology 220 that could be followed in regard to the particular task example. In accordance with the ontology, the task of translating the article could be partitioned into smaller tasks of translating respective paragraphs. Each such task could be further partitioned into even smaller tasks, of individually translating each sentence of a paragraph.

Referring to FIG. 3, there are shown steps for a method comprising an embodiment of the invention. More particularly, the embodiment pertains to the task example described above in connection with FIG. 2, wherein the task is to translate a body of text from a first or source language to a second or target language.

At step 302, the translation task is submitted. The submission must be accompanied by certain important information, including the task type, the textual content that is to be translated, and the source and target languages pertaining to the translation task. An incentive amount for performing the task is also initially specified. An example of a skill required for a task provider would be a knowledge of both the source and target languages.

At step 304, metrics or other elements which indicate the complexity of the submitted task are evaluated. Generally, one or more metrics are preselected for use in evaluating complexity, wherein each metric used to evaluate a given task is based on the type of that task. At step 304, the values of the pertinent metrics for the task are determined. For the task of translating an amount of text from one natural language to another, useful metrics for evaluating task complexity would be the number of words, the number of sentences, and/or the number of paragraphs, respectively, included in the text.

As a further example of complexity evaluation metrics, a task could be of a type that requires testing of software. A metric for this type of task could be the number of steps that need to be executed in carrying out the test procedure. An alternative metric could be the complexity of the code, such as whether the code pertains to search or to a process controller.

Decision step 306 determines whether the submitted task is or is not complex. To accomplish this, each metric value determined at step 304 for the task is applied to a prespecified rule pertaining to that task. For example, for the translation type of task, the rule could be that one of such tasks would be complex only if it contained more than two paragraphs, and each paragraph contained more than one sentence.

For a software testing type of task, a rule could be that such task is complex only if the total number of test steps exceeds a prespecified limit. Also, task complexity evaluation component 104 of FIG. 1 could be used to carry out the complexity evaluation of steps 304 and 306.

If step 306 decides that the task is complex, the method of FIG. 3 proceeds to decision step 308, and otherwise proceeds to decision step 310. Step 308 is provided to assess the crowdsourcing marketplace that pertains to the complex task. More particularly, step 308 determines whether all crowdsourcing skills are available to complete the complex task, in accordance with all requirements that have been prespecified for the task. One important requirement could be that the task must be completed within a given time. Other requirements could, for example, be certain quality levels that must be achieved in completing the task.

In assessing the crowdsourcing marketplace at step 308, a number of related elements are usefully considered. One element is the number of available crowdsourcing agents that each has the particular skill or skill set required for the complex task. For each such agent, it would also be useful to know the pertinent history of the agent. This could include the number of tasks, of the same or similar type as the complex task, which the agent has previously completed.

Other useful information for the marketplace assessment of step 308 would be the number of requests for tasks made by others, wherein the requested tasks are the same as or similar to the task of step 308. Such information could include the total number of the requesters, and the incentives or other price information associated with each of their task requests. The number of requests for same or similar tasks that remain to be completed could also be useful information.

To carry out step 308 for a complex task, one or more metrics are usefully constructed from elements such as those described above, although the invention is not limited thereto. Each constructed metric would be given a value for the task, and then applied to a prespecified rule. Based on the particular metric values, the rule would indicate whether or not crowdsourcing resources were sufficiently available for the complex task to be completed as required by step 308. If so, the method proceeds to step 312 and the task is left unchanged. The method of FIG. 3 then ends.

If it is determined at step 308 that sufficient crowdsourcing resources for the complex task are not available, the method goes to step 314. At this step the complex task is broken into two or more smaller or atomic tasks. Each atomic task is selected to be small enough to ensure that adequate crowdsourcing resources will be available to readily complete the atomic task. At step 316, an appropriate incentive is specified for each atomic task.

Referring further to FIG. 3, decision step 310 determines whether the initial incentive selected for the task submitted at step 302 is large enough to meet crowdsourcing market conditions. For example, available crowdsourcing providers might want an incentive amount that is greater than the initial incentive, in order for them to consider performing the task. If the decision at step 310 is affirmative, the method proceeds to step 318 and the task is left unchanged. The method of FIG. 3 then ends.

If the decision at step 310 is negative, the method proceeds to step 320. This step combines the task with one or more other tasks into a bundled task. As described above, the incentive required to crowdsource multiple atomic tasks which are bundled together can be significantly less than the total incentive required to crowdsource them individually. At step 322, an appropriate incentive is set for the bundled task, and the method ends.

FIG. 4 is a pictorial representation of a network of data processing systems in which illustrative embodiments of the invention may be implemented. Network data processing system 400 is a network of computers in which the illustrative embodiments may be implemented. Network data processing system 400 contains network 402, which is the medium used to provide communications links between various devices and computers connected together within network data processing system 400. Network 402 may include connections, such as wire, wireless communication links, or fiber optic cables.

In the depicted example, server computer 404 and server computer 406 connect to network 402 along with storage unit 408. In addition, client computers 410, 412, and 414 connect to network 402. Client computers 410, 412, and 414 may be, for example, personal computers or network computers. In the depicted example, server computer 404 provides information, such as boot files, operating system images, and applications to client computers 410, 412, and 414. Client computers 410, 412, and 414 are clients to server computer 404 in this example. Network data processing system 400 may include additional server computers, client computers, and other devices not shown.

Program code located in network data processing system 400 may be stored on a computer-recordable storage medium and downloaded to a data processing system or other device for use. For example, program code may be stored on a computer-recordable storage medium on server computer 404 and downloaded to client computer 410 over network 402 for use on client computer 410.

In the depicted example, network data processing system 400 is the Internet with network 402 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational and other computer systems that route data and messages. Of course, network data processing system 400 also may be implemented as a number of different types of networks, such as, for example, an intranet, a local area network (LAN), or a wide area network (WAN). FIG. 4 is intended as an example, and not as an architectural limitation for the different illustrative embodiments.

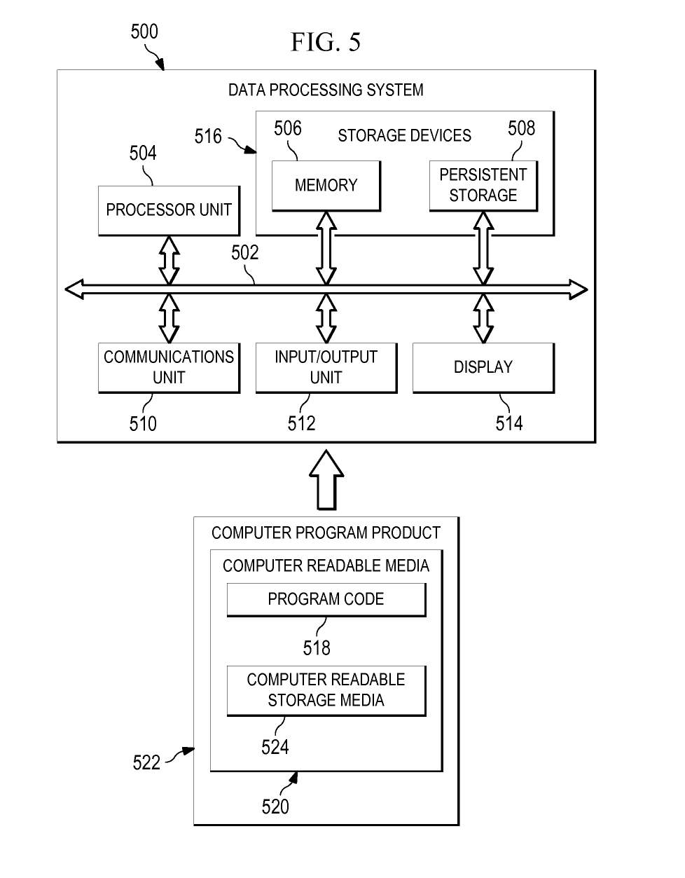

Turning now to FIG. 5, an illustration of a data processing system is depicted in accordance with an illustrative embodiment. The data processing system may be used as one or more of the components for system 100. In this illustrative example, data processing system 500 includes communications fabric 502, which provides communications between processor unit 504, memory 506, persistent storage 508, communications unit 510, input/output (I/0) unit 512, and display 514.

Processor unit 504 serves to execute instructions for software that may be loaded into memory 506. Processor unit 504 may be a number of processors, a multi-processor core, or some other type of processor, depending on the particular implementation. A number, as used herein with reference to an item, means one or more items. Further, processor unit 504 may be implemented using a number of heterogeneous processor systems in which a main processor is present with secondary processors on a single chip. As another illustrative example, processor unit 504 may be a symmetric multi-processor system containing multiple processors of the same type.

Memory 506 and persistent storage 508 are examples of storage devices 516. A storage device is any piece of hardware that is capable of storing information, such as, for example, without limitation, data, program code in functional form, and/or other suitable information either on a temporary basis and/or a permanent basis. Storage devices 516 may also be referred to as computer-readable storage devices in these examples. Memory 506, in these examples, may be, for example, a random access memory or any other suitable volatile or non-volatile storage device. Persistent storage 508 may take various forms, depending on the particular implementation.

For example, persistent storage 508 may contain one or more components or devices. For example, persistent storage 508 may be a hard drive, a flash memory, a rewritable optical disk, a rewritable magnetic tape, or some combination of the above. The media used by persistent storage 508 also may be removable. For example, a removable hard drive may be used for persistent storage 508.

Communications unit 510, in these examples, provides for communications with other data processing systems or devices. In these examples, communications unit 510 is a network interface card. Communications unit 510 may provide communications through the use of either or both physical and wireless communications links.

Input/output unit 512 allows for input and output of data with other devices that may be connected to data processing system 500. For example, input/output unit 512 may provide a connection for user input through a keyboard, a mouse, and/or some other suitable input device. Further, input/output unit 512 may send output to a printer. Display 514 provides a mechanism to display information to a user.

Instructions for the operating system, applications, and/or programs may be located in storage devices 516, which are in communication with processor unit 504 through communications fabric 502. In these illustrative examples, the instructions are in a functional form on persistent storage 508. These instructions may be loaded into memory 506 for execution by processor unit 504. The processes of the different embodiments may be performed by processor unit 504 using computer implemented instructions, which may be located in a memory, such as memory 506.

These instructions are referred to as program code, computer-usable program code, or computer-readable program code that may be read and executed by a processor in processor unit 504. The program code in the different embodiments may be embodied on different physical or computer-readable storage media, such as memory 506 or persistent storage 508.

Program code 518 is located in a functional form on computer-readable media 520 that is selectively removable and may be loaded onto or transferred to data processing system 500 for execution by processor unit 504. Program code 518 and computer-readable media 520 form computer program product 522 in these examples. In one example, computer-readable media 520 may be computer-readable storage media 524. Computer-readable storage media 524 may include, for example, an optical or magnetic disk that is inserted or placed into a drive or other device that is part of persistent storage 508 for transfer onto a storage device, such as a hard drive, that is part of persistent storage 508. Computer-readable storage media 524 also may take the form of a persistent storage, such as a hard drive, a thumb drive, or a flash memory, that is connected to data processing system 500. In some instances, computer-readable storage media 524 may not be removable from data processing system 500.

The different components illustrated for data processing system 500 are not meant to provide architectural limitations to the manner in which different embodiments may be implemented. The different illustrative embodiments may be implemented in a data processing system including components in addition to or in place of those illustrated for data processing system 500. Other components shown in FIG. 5 can be varied from the illustrative examples shown. The different embodiments may be implemented using any hardware device or system capable of running program code. As one example, the data processing system may include organic components integrated with inorganic components and/or may be comprised entirely of organic components excluding a human being. For example, a storage device may be comprised of an organic semiconductor.

In another illustrative example, processor unit 504 may take the form of a hardware unit that has circuits that are manufactured or configured for a particular use. This type of hardware may perform operations without needing program code to be loaded into a memory from a storage device to be configured to perform the operations.

For example, when processor unit 504 takes the form of a hardware unit, processor unit 504 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, programmable array logic, a field programmable logic array, a field programmable gate array, and other suitable hardware devices. With this type of implementation, program code 518 may be omitted because the processes for the different embodiments are implemented in a hardware unit.

In still another illustrative example, processor unit 504 may be implemented using a combination of processors found in computers and hardware units. Processor unit 504 may have a number of hardware units and a number of processors that are configured to run program code 518. With this depicted example, some of the processes may be implemented in the number of hardware units, while other processes may be implemented in the number of processors.

As another example, a storage device in data processing system 500 is any hardware apparatus that may store data. Memory 506, persistent storage 508, and computer-readable media 520 are examples of storage devices in a tangible form.

In another example, a bus system may be used to implement communications fabric 502 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 506, or a cache, such as found in an interface and memory controller hub that may be present in communications fabric 502.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1. In association with a system disposed to post software related tasks to a crowdsourcing marketplace for execution, a method comprising the steps of:
prior to posting a specified task to the crowdsourcing marketplace, determining whether or not the specified task comprises a complex task;
responsive to determining that the specified task comprises a complex task, evaluating the task with respect to at least a first criterion, to determine whether the specified task should be decomposed into two or more atomic tasks; and
responsive to determining that the specified task does not comprise a complex task, evaluating the task with respect to at least a second criterion, to determine whether the specified task should be combined with one or more other tasks into a bundled task.

2. The method of claim 1, wherein:
each of the atomic tasks comprises a discrete identifiable task that must be executed, in order to completely execute the specified task.

3. The method of claim 1, wherein:
determining whether the specified task comprises a complex task includes defining one or more metrics that each pertains to task complexity, wherein a value for each metric is derived from one or more parameters associated with the specified task.

4. The method of claim 3, further wherein:
each of the metric values is applied to a prespecified rule in order to determine whether the specified task comprises a complex task.

5. The method of claim 1, wherein:
evaluating the specified task with respect to the first criterion comprises determining whether a prespecified requirement will be complied with, if the prespecified task is submitted to the crowdsourcing marketplace for completion without being decomposed into atomic tasks.

6. The method of claim 5, wherein:
the prespecified requirement is that the specified task will be completed by a prespecified time.

7. The method of claim 5, wherein:
determining whether the prespecified requirement will be complied with comprises assessing at least one element selected from a group of crowdsourcing marketplace elements, consisting of the number of crowdsourcing agents that each has a skill set required for the specified task; the number of tasks each agent has previously completed that are of the same type as the specified task; the current number of task requests posted by others to the crowdsourcing marketplace, wherein the tasks of the posted requests are of the same type as the specified task and have not yet been completed; and price information associated with the posted task requests.

8. The method of claim 1, further comprising the step of:
responsive to determining that the specified task should be decomposed into a given number of atomic tasks comprising two or more, decomposing the specified task into the given number of atomic tasks, for submission to the crowdsourcing marketplace.

9. The method of claim 1, wherein:
the second criterion comprises an initial monetary incentive assigned to the specified task.

10. The method of claim 9, wherein:
evaluating the specified task with respect to the second criterion comprises comparing the initial incentive with other incentives in the crowdsourcing marketplace that are associated with tasks of the same type as the specified type.

11. The method of claim 10, further comprising the step of:
responsive to determining that the specified task should be combined with one or more other tasks, combining the specified task with a given number of other tasks into a bundled task for submission to the crowdsourcing marketplace.

12. The method of claim 11, further comprising the step of:
assigning a selected incentive to the bundled task.

13-20. (canceled)
